(19) United States
(12) Patent Application Publication
(10) Pub. No.: US 2008/0207293 A1
(43) Pub. Date: Aug. 28, 2008

(54) GAMING MACHINE, METHOD FOR CONTROLLING A GAMING MACHINE, AND METHOD FOR PLAYING A GAME

(75) Inventor: Hirobumi TOYODA, Tokyo (JP)

Correspondence Address: ARENT FOX LLP, 1050 CONNECTICUT AVENUE, N.W., SUITE 400, WASHINGTON, DC, 20036, US

(73) Assignee: Aruze Corp., Tokyo (JP)

(21) Appl. No.: 11/939,170

(22) Filed: Nov. 13, 2007

(30) Foreign Application Priority Data
Nov. 15, 2006 (JP) 2006-309028

(51) Int. Cl. A63F 13/00; G06F 17/00

(52) U.S. Cl. 463/13; 463/25

(57) ABSTRACT

A gaming machine includes a display and a controller. The controller controls the display so as to display an image related to a win game. The controller is configured with logic to: (a) distribute cards to a player; (b) replace one or more of the distributed cards selected by the player with different cards; (c) executes a win game in which the player wins a predetermined award when the final cards possessed by the player includes a predetermined card combination; (d) continuously execute a plurality of subsequent win games in a high-probability mode when the card combination entitled to the award matches a predetermined special combination; and (e) terminate the win game in the high-probability mode, when awards provided during a first predetermined number of the win games have satisfied a predetermined condition.

This application is based on and claims the benefit of priority from Japanese Patent Application No. 2006-309028, filed on 15 Nov. 2006, the content of which is incorporated herein by reference.

### BACKGROUND OF THE INVENTION

1. Field of the Invention

The present invention relates to a gaming machine, a method for controlling a gaming machine, and a method for playing a game.

2. Related Art

With conventional gaming machines installed in an amusement facility, a win game is executed. If the cards distributed to a player in the final stage include multiple cards that match a predetermined special combination, the player wins the game. The player receives medals for each winning poker game according to the number of medals inserted and the rank of the poker hand won by the player (the card combination entitled to an award).

In recent years, gaming machines have been provided which execute a high-probability win game in which a player has an increased probability of winning. For example, a gaming machine is provided which distributes two sets of five cards, greater than the five cards of conventional poker games. With such an arrangement, the player can form a card combination involving the two sets of five cards so as to win the poker hand (U.S. Pat. No. 5,882,260).

Furthermore, in recent years, an additional new game style is offered, i.e., a double down game. With such an arrangement, after a player has won a hand of poker, the player can play a double down game in which the player can win twice the number of medals as in the normal game.

### SUMMARY OF THE INVENTION

It is an object of the present invention to provide a gaming machine having a new game style that allows the player to feel more expected of the payout of medals, a control method for the gaming machine, and a play method for the game.

In an aspect of the present invention, a gaming machine is provided, which includes a display and a controller. The controller controls the display so as to display an image related to a win game. The controller is configured with logic to: (a) distribute cards to a player; (b) replace one or more of the distributed cards selected by the player with different cards; (c) execute a win game in which the player wins a predetermined award when the final cards possessed by the player includes a predetermined card combination; (d) continuously execute a plurality of subsequent win games in a high-probability mode when the card combination entitled to the award matches a predetermined special combination; and (e) terminate the win game in the high-probability mode, when awards provided during a first predetermined number of the win games have satisfied a predetermined condition.

In another aspect of the present invention, a gaming machine is provided, in which the controller is further configured with logic to (f) terminate the win game in the high-probability mode, when a low award has been continuously provided equal to or more than a second predetermined number of times.

In still another aspect of the present invention, a gaming machine is provided, in which the controller is further configured with logic to (g) terminate the win game in the high-probability mode, when a same award has been continuously provided equal to or more than a third predetermined number of times.

In yet another aspect of the present invention, a gaming machine is provided, which includes a display and a controller. The controller controls the display so as to display an image related to a win game. The controller is configured with logic to: (a) distribute cards to a player; (b) replace one or more of the distributed cards selected by the player with different cards; (c) execute a win game in which the player wins a predetermined award when the final cards possessed by the player includes a predetermined card combination; (d) continuously execute a plurality of subsequent win games in a high-probability mode when the card combination entitled to the award matches a predetermined special combination; (e) terminate the win game in the high-probability mode, when awards provided during a first predetermined number of the win games have satisfied a predetermined condition; and (f) terminate the win game in the high-probability mode, when a low award has been continuously provided equal to or more than a second predetermined number of times.

In a further aspect of the present invention, a gaming machine is provided, which includes a display and a controller. The controller controls the display so as to display an image related to a win game. The controller is configured with logic to: (a) distribute cards to a player; (b) replace one or more of the distributed cards selected by the player with different cards; (c) execute a win game in which the player wins a predetermined award when the final cards possessed by the player includes a predetermined card combination; (d) continuously execute a plurality of subsequent win games in a high-probability mode when the card combination entitled to the award matches a predetermined special combination; (e) terminate the win game in the high-probability mode, when awards provided during a first predetermined number of the win games have satisfied a predetermined condition;(f) terminate the win game in the high-probability mode, when a low award has been continuously provided equal to or more than a second predetermined number of times; and (g) terminate the win game in the high-probability mode, when a same award has been continuously provided equal to or more than a third predetermined number of times.

In a still further aspect of the present invention, a method of controlling a gaming machine is provided. The method includes the steps of: (a) distributing cards to a player; (b) replacing one or more of the distributed cards selected by the player with different cards; (c) executing a win game in which the player wins a predetermined award when the final cards possessed by the player includes a predetermined card combination; (d) continuously executing a plurality of subsequent win games in a high-probability mode when the card combination entitled to the award matches a predetermined special combination; and (e) terminating the win game in the high-probability mode, when awards provided during a first predetermined number of the win games have satisfied a predetermined condition.

In a yet further aspect of the present invention, a method of executing a win game is provided. The method includes the steps of: (a) distributing cards to a player; (b) replacing one or more of the distributed cards selected by the player with different cards; (c) executing a win game in which the player wins a predetermined award when the final cards possessed by the player includes a predetermined card combination; (d) continuously executing a plurality of subsequent win games in a high-probability mode when the card combination entitled to the award matches a predetermined special combination; and (e) terminating the win game in the high-probability mode, when awards provided during a first predetermined number of the win games have satisfied a predetermined condition.

The present invention provides a gaming machine having a new style of game that enhances the player's sense of expectation with respect to the payout of medals, a control method for the gaming machine, and a play method of the game.

### BRIEF DESCRIPTION OF THE DRAWINGS

FIG. 1 is a flowchart showing a game flow according to the present invention;

FIG. 2 is a schematic diagram illustrating a configuration of a poker gaming machine according to the present invention;

FIG. 3 is a block diagram illustrating an electric configuration of the poker gaming machine according to the present invention;

FIG. 4 is a flowchart showing a processing flow of the poker gaming machine according to the present invention;

FIG. 5 is a flowchart showing a processing flow of the poker gaming machine according to the present invention;

FIG. 6 is a flowchart showing a processing flow of the poker gaming machine according to the present invention;

FIG. 7 is a flowchart showing a processing flow of the poker gaming machine according to the present invention;

FIG. 8 is a flowchart showing a processing flow of the poker gaming machine according to the present invention;

FIG. 9 is a flowchart showing a processing flow of the poker gaming machine according to the present invention;

FIGS. 10A and 10B are schematic diagrams illustrating display screens displayed on the poker gaming machine according to the present invention;

FIGS. 11A and 11B are schematic diagrams illustrating display screens displayed on the poker gaming machine according to the present invention;

FIGS. 12A and 12B are schematic diagrams illustrating display screens displayed on the poker gaming machine according to the present invention;

FIGS. 13A and 13B are schematic diagrams illustrating display screens displayed on the poker gaming machine according to the present invention; and

FIGS. 14A and 14B are schematic diagrams illustrating display screens displayed on the poker gaming machine according to the present invention.

### DETAILED DESCRIPTION OF THE INVENTION

a. Outline of Play Method

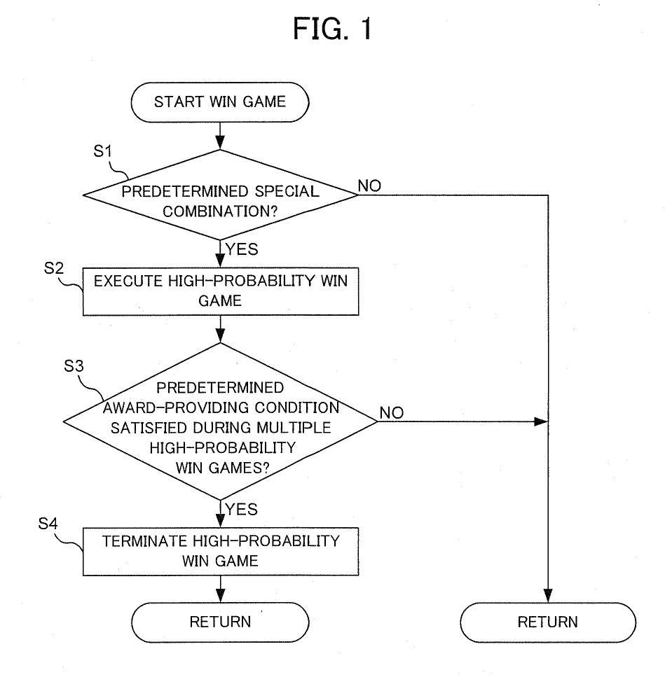

FIG. 1 is a flowchart showing a play method according to an embodiment of the present invention. The play method according to the present embodiment relates to a type of poker game, in which a win game is executed. In this play method, multiple types of cards are employed. First, multiple cards are distributed, and the cards thus distributed are exchanged for other cards according to a player's operation. When the cards thus distributed in the final stage include multiple cards that form a predetermined special combination, the player receives a predetermined award. The play method determines in the win game whether or not a combination of cards entitled to an award matches a predetermined special combination (e.g., heart or diamond flush) (Step S1).

Furthermore, when the combination of cards matches the predetermined special combination, the play method continuously executes a plurality of subsequent win games in a high-probability win game mode which offers the player an increased probability of winning (Step S2). Furthermore, the play method makes a comparison among a plurality of game results, and determines whether a predetermined award-providing condition has been satisfied (Step S3). When the predetermined award-providing condition has been satisfied, the CPU 66 terminates the high-probability win game (Step S4).

b. Configuration of Poker Gaming Machine

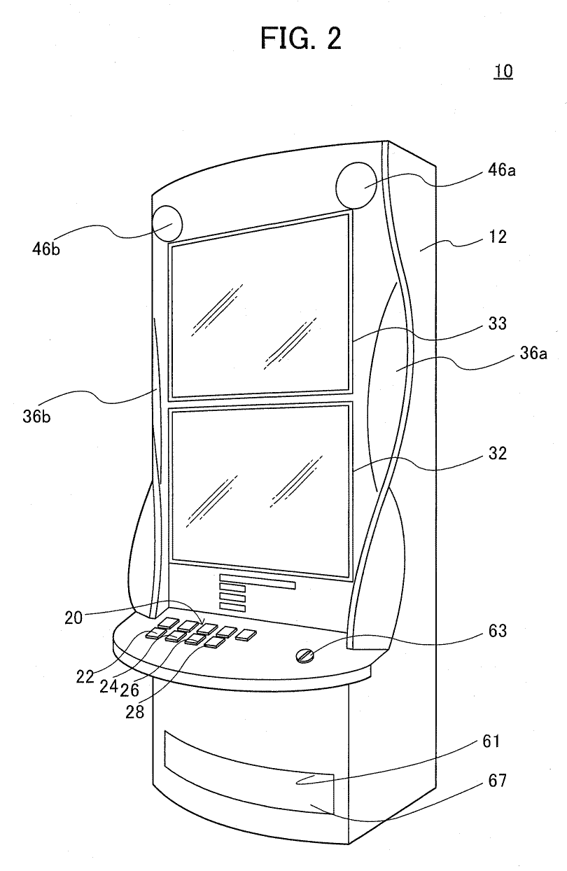

FIG. 2 is a schematic view of a gaming machine according to an embodiment of the present invention. It should be noted that a poker gaming described below is an example of a gaming machine according to an embodiment of the present invention.

A description is given of a poker gaming machine employing medals, for example, in the present embodiment. However, the gaming machine according to the present invention may employ various types of gaming media. Examples of such gaming media include coins, medals, tokens, a card that stores the gaming value information, etc.

A first display 32 is provided on a front face of a poker gaming machine 10. Furthermore, a second display 33 is provided above the first display 32. The first display 32 displays cards distributed to a player, and a prize table that shows card combinations entitled to awards. The second display 33 displays images of rendered effects. A detailed description is provided later regarding the rendered effects displayed on the first display 32 and the second display 33.

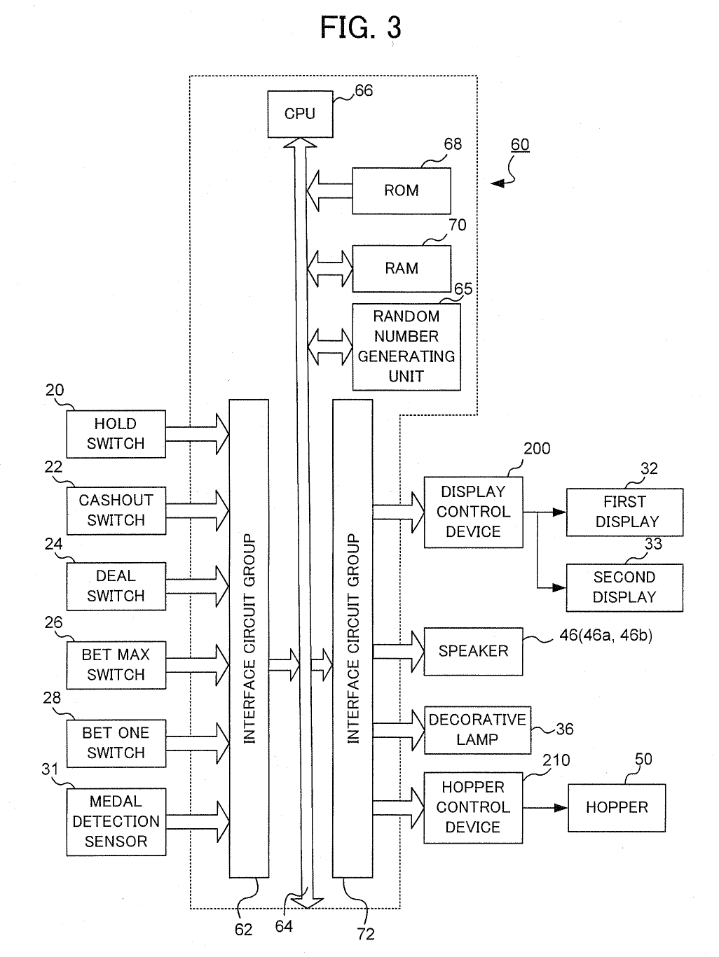

A medal insertion opening 63 is provided in the vicinity of the right portion of the front face of the poker gaming machine 10. Moreover, a medal payout opening 61 and a medal tray 67 are provided at the lower portion of the front face thereof. When the player inserts a medal into the medal insertion opening 63, a game is ready to start. Medals are paid out from the medal payout opening 61 according to the game results, and stored in the medal tray 67. As described later, the poker gaming machine 10 has a medal detection sensor 31 (see FIG. 3) built-in. When the player inserts a medal into the poker gaming machine 10, the medal detection sensor 31 detects it.

Furthermore, speakers 46a and 46b are provided at upper portions of the poker gaming machine. The speakers 46a and 46b generate effect sounds, etc., synchronized with the progress of the game.

Various types of switches are provided under the first display 32, which allow the player to advance the game. A BET MAX switch 26 and a BET ONE switch 28 allow the player to start a game. The number of medals bet on the game is incremented every time the player pushes the BET ONE switch 28. The BET MAX switch 26 allows the player to bet five medals, i.e., the maximum number of medals, by performing a single pushing operation.

A DEAL switch 24 and a CASH OUT switch 22 are disposed on the left side of the BET MAX switch 26. Five hold switches 20 are disposed on the upper side of the BET MAX switch 26. The DEAL switch 24 allows the player to have a display of the cards. When the player performs a pushing operation on the DEAL switch 24 after inserting medals, images such as the distributed cards and the newly exchanged cards are displayed on the first display 32.

The CASH OUT switch 22 allows the player to issue an instruction to pay out the medals stored in the poker gaming machine 10 (which is referred to as “medals stored as credits” hereafter). When the player turns on the CASH OUT switch 22 by performing a pushing operation, the medals are paid out to the medal tray 67.

There are five HOLD switches 20 in total. The HOLD switches 20 are disposed such that they correspond to the respective card images displayed on the first display 32. The HOLD switches 20 allow the player to select cards which she desires to keep without exchange after the cards are displayed. When the player turns on a HOLD switch 20 positioned under a card selected from the five cards displayed on the first display 32, the card thus selected is not exchanged.

c. Configuration of a Control Unit of a Poker Gaming Machine

FIG. 3 is a block diagram showing a control circuit of the poker gaming machine according to the embodiment of the present invention.

A main control circuit 60 serving as a controller includes a central processing device (referred to as a “CPU” hereafter) 66; read only memory (referred to as “ROM” hereafter) 68; random access memory (referred to as “RAM” hereafter) 70; a random number generation unit 65; and interface circuit groups 62 and 72. These components are connected with one another via an input/output bus 64.

The input/output bus 64 allows data signals, control signals, and address signals to be input and output to and from the CPU 66.

The CPU 66 writes and reads data to and from components and devices connected with the input/output bus 64 according to a computer program stored in the ROM 68, thereby performing various types of processing in cooperation with these components and devices. A timer (not shown), which is described later, is included in the CPU 66.

The aforementioned medal detection sensor 31 is connected to the interface circuit group 62 in the main control circuit 60. A detection signal sent from the medal detection sensor 31 is converted into a predetermined signal by the interface circuit group 62. The detection signal thus converted is supplied to the input/output bus 64.

The aforementioned DEAL switch 24 is connected to the interface circuit group 62. The DEAL switch 24 transmits a signal indicating detection of turning on in response to a pushing operation by the player to the interface circuit group 62. The signal thus transmitted is supplied to the input/output bus 64.

The HOLD switches 20, the CASH OUT switch 22, the BET MAX switch 26, and the BET ONE switch 28 are connected to the interface circuit group 62. When the player turns on any of these switches by performing a pushing operation, a signal indicating detection of a pushing operation is transmitted to the interface circuit group 62. The signal is supplied to the input/output bus 64.

The speakers 46 (46a and 46b) and decorative lamps 36 (36a and 36b) are connected to the interface circuit group 72. Supplying a driving signal or driving electric power according to the results of computation processing performed by the CPU 66, the interface circuit group 72 controls each of the aforementioned devices.

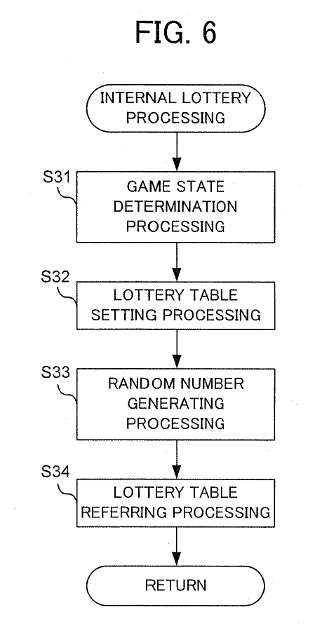

The ROM 68 and the RAM 70 serving as storage means are connected to the input/output bus 64. The ROM 68 stores a control program which controls the overall flow of the game provided by the poker gaming machine 10. The ROM 68 stores: initial data for executing the control program; a program for controlling an on-off pattern of the decorative lamps 36 (36a and 36b (see FIG. 2)); a program for performing display control of the first display 32; etc. The ROM 68 also stores: multiple types of lottery tables for associating a random number sampled by the random number generation unit 65 with a card image to be displayed on the first display 32; a combination table for determining whether or not a combination of the cards displayed on the first display 32 matches a predetermined special combination; etc. In addition, the multiple lottery tables specify different winning probabilities. For example, when the predetermined special combination has occurred, the CPU 66 selects a table of high-probability win game, which provides a higher probability of winning than a normal game (see FIG. 6).

The ROM 70 stores flags and variables used in the aforementioned programs, examples of which include a game mode flag, a high-probability win game counter, etc.

The random number generation unit 65 is connected to the input/output bus 64. When the CPU 66 transmits an instruction to generate a random number to the random number generation unit 65, the random number generation unit 65 generates a random number in a predetermined range. The random number generation unit 65 transmits a signal indicating the generated random number to the input/output bus 64. The CPU 66 performs internal lottery processing based upon the random number thus generated, as described later. In addition, the random number transmitted from the random number generation unit 65 is stored in the RAM 70.

With the present embodiment, the random number is sampled by the random number generation unit 65 connected to the CPU 66 via the input/output bus 64. However, the present invention is not restricted to such an arrangement. It may be alternatively possible that the CPU 66 executes sampling of random numbers. In this case, the random number generation unit 65 may be omitted.

A display control device 200 is connected to the interface circuit group 72. Receiving an instruction to display an image transmitted from the main control circuit 60, the display control device 200 transmits a signal indicating driving of the first display 32 and the second display 33, which are connected to the display control device 200.

A hopper control device 210 is connected to the interface circuit group 72. Receiving an instruction to pay out a medal transmitted from the main control circuit 60, the hopper control device 210 transmits a signal indicating driving of a hopper 50 connected to the hopper control device 210. Upon driving the hopper 50, the CPU 66 supplies medals to the medal tray 67 through the medal payout opening 61.

d. Operation of a Poker Gaming Machine

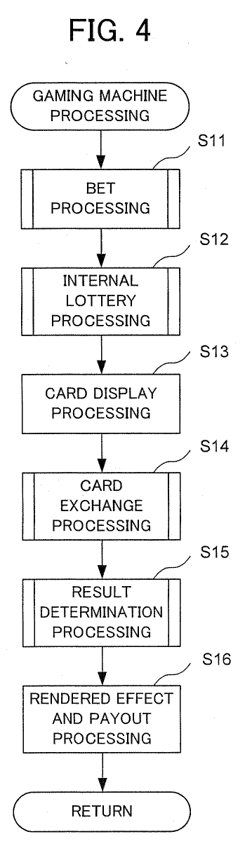

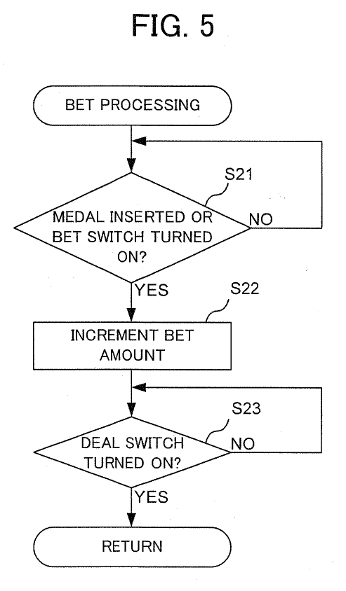

FIG. 4 is a flowchart showing a main routine which is executed by the aforementioned main control circuit 60 for controlling the poker gaming machine 10. FIGS. 5 through 9 are flowcharts, each of which shows a subroutine of the aforementioned main flowchart.

A description is provided below assuming the following conditions: first, that the poker gaming machine 10 has been started up beforehand; second, that the variables used by the aforementioned CPU 66 are initialized to predetermined values; and third, that the poker gaming machine 10 is operating normally.

First, as shown in FIG. 4, the CPU 66 executes bet processing (Step S11). In this processing, the CPU 66 performs the bet processing in response to an operation by a player, such as the insertion of a coin, and turning on the BET MAX switch 26 or the BET ONE switch 28. A detailed description is provided later regarding the bet processing. Upon completion of the bet processing, the CPU 66 advances the processing to Step S12.

In Step S12, the CPU 66 performs an internal lottery so as to execute card selection processing. In this processing, the CPU 66 transmits an instruction to generate a random number to the random number generation unit 65. Upon reception of this command signal, the random number generation unit 65 samples a random number. The generated random number is stored in the RAM 70 as a random number indicating the lottery result. The CPU 66 determines the type of a card in accordance with the stored random number with reference to the lottery table. The data related to the type of the card is then stored in the RAM 70. A detailed description is provided later regarding the internal lottery processing. Upon completion of the internal processing, the CPU 66 advances the processing to Step S13.

The CPU 66 performs card display processing in Step S13. The CPU 66 transmits an instruction to display a card image and data related to the types of five cards to the display control device 200. The five cards are to be distributed in the first place to the player out of the cards, which are determined by the internal lottery in the Step S12. The CPU 66 performs the transmission via the input/output bus 64 and the interface circuit group 72. The display control device 200 reads out the corresponding image data, and stores the image data thus read out in video RAM in the display control device 200. As a result, the first display 32 displays the five cards first distributed to the player. Upon completion of the card display processing, the CPU 66 advances the processing to Step S14.

The CPU 66 executes card exchange processing in Step S14. In this processing, the CPU 66 displays new card images on the first display 32 in response to a card exchange operation by the player. Before displaying the new card images, the CPU 66 determines whether or not the five cards to be displayed as a result of the card exchange processing matches a predetermined special combination. The CPU 66 changes the order of displaying the cards based upon the determination results.

A detailed description is provided later regarding this processing. Upon completion of the card exchange processing, the CPU 66 advances the processing to Step S15.

In Step S15, the CPU 66 determines whether the card combination of the five cards displayed on the first display 32 as a result of the card exchange processing is entitled to an award. This determination is made with reference to the combination table stored in the RAM 70. It should be noted that if the CPU 66 performs determination in step S14 with respect to all the predetermined combinations entitled to an award in addition to the predetermined special combination, the processing in step S15 can be skipped. A detailed description is provided later regarding this processing. Upon completion of the result determination processing, the CPU 66 advances the processing to Step S16.

The CPU 66 executes processing for performing rendered effects and payout in accordance with the determination results made in the Step S16. Specifically, when a card combination entitled to an award has occurred, the CPU 66 controls the first display 32 to display the information related to the award. At the same time, the CPU 66 controls the number of medals won by the player to be added to the credit amount. On the other hand, when a card combination entitled to an award has not occurred, the CPU 66 controls the first display 32 to display the information about unsuccessful results. Upon completion of the rendered effects processing and the payout processing, the CPU 66 terminates the main routine.

As described above, the CPU 66 performs the processing in Steps S11, S12, S15, and S16 for controlling the execution of the win game.

e. Bet Processing

In the aforementioned Step S11 (FIG. 4), a bet processing subroutine shown in FIG. 5 is called.

First, the CPU 66 executes processing for determining whether or not a medal has been inserted, or whether or not the bet switch has been activated (Step S21). In this processing, the CPU 66 determines whether or not the CPU 66 has received from the medal detection sensor 31 a detection signal, which indicates that a medal has been inserted into the medal insertion opening 63, and whether or not the CPU 66 has received a detection signal, which indicates that either the BET MAX switch 26 or the BET ONE switch 28 has been activated. When the CPU 66 has determined the reception of either of these signals, it advances the processing to Step S22. Otherwise, the CPU 66 repeatedly performs the processing denoted by this step.

In Step S22, the CPU 66 increments a credit amount in accordance with the results obtained in the Step S21. Specifically, the CPU 66 controls the RAM 70 to store the sum of the number of detections of coin insertion and the number of times the BET ONE switch 28 has been activated as a bet amount. It should be noted that the maximum bet amount is set to “5”. When the BET MAX switch 26 is activated, the CPU 66 controls the maximum bet amount “5” to be stored in the RAM 70, regardless of the number of detections of coin insertion and the number of times the BET ONE switch 28 has been activated. Upon completion of the bet amount increment processing, the CPU 66 advances the processing to Step S23.

In Step S23, the CPU 66 determines whether or not to have received a detection signal indicating that the DEAL switch 24 has been activated. When the CPU 66 determines no reception of the detection signal, it repeatedly performs the processing denoted by this step until reception of the detection signal. Upon determining the reception of the detection signal, the CPU 66 terminates this bet processing subroutine.

f. Internal Lottery Processing

In the aforementioned Step S12 (FIG. 4), an internal lottery processing subroutine shown in FIG. 6 is called.

In Step S31, the CPU 66 performs processing for determining a game mode based upon a game mode flag stored in the RAM 70. Upon completion of this processing, the CPU 66 advances the processing to Step S32.

In Step S32, the CPU 66 selects a lottery table from the multiple types of tables specifying different winning probabilities, which are stored in the ROM 68, based upon the game mode determined in Step S31. Furthermore, the CPU 66 controls the lottery table thus selected to be stored in the RAM 70. Upon completion of this processing, the CPU 66 advances the processing to Step S33.

In Step S33, the CPU 66 transmits an indication to generate a random number to the random number generation unit 65 so as to sample a random number. The CPU 66 controls the random number to be stored in the RAM 70 as a random number indicating the lottery result. Upon completion of this processing, the CPU 66 advances the processing to Step S34.

In Step S34, the CPU 66 performs lottery table reference processing. In this processing, the CPU 66 determines cards that correspond to random numbers stored in the RAM 70 in Step S33 with reference to the lottery table set in Step S32. Then, the CPU 66 controls the data related to the cards to be stored in the RAM 70. Upon completion of this processing, the CPU 66 terminates this subroutine.

In this processing, ten cards are selected from the cards available for a game. With respect to the ten cards thus selected, five cards are first displayed to the player, and the other five cards are kept in stock, which may be displayed to the player according to the card exchange. The five cards first displayed to the player are always displayed on the first display 32. When a game to start is in a high-probability win mode, at least one of the five cards first displayed is a joker, which is a special card that can serve as multiple types of cards. The joker increases the probability that a card combination is entitled to an award. On the other hand, only the desired number of cards, which are selected from the other five cards kept in stock in response to the request of exchange by the player, are displayed on the first display 32. It should be noted that in the present embodiment the cards for exchange are selected in the same lottery, in which the cards to be first displayed to the player are determined. However, the present invention is not restricted to such an arrangement. It may be alternatively possible to determine cards by a separate lottery after the number of cards to be exchanged is determined.

g. Card Exchange Processing

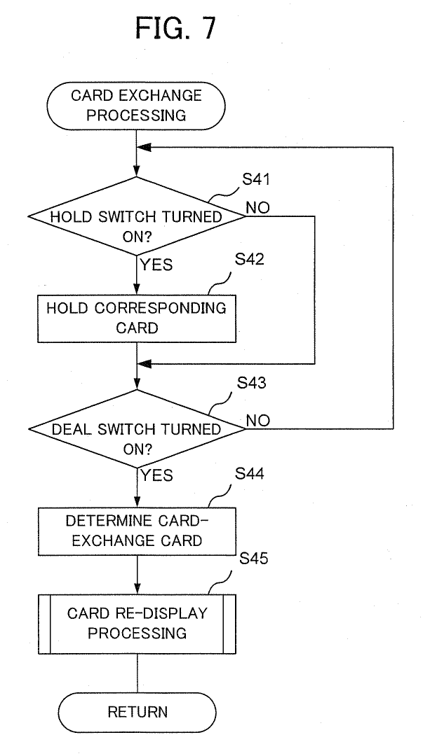

In the aforementioned Step S14 (FIG. 4), a card exchange processing subroutine shown in FIG. 7 is called.

First, the CPU 66 executes the processing for determining whether or not the HOLD switch 20 has been activated (Step S41). In this processing, the CPU 66 determines whether or not to have received a signal indicating detection of any one of the five HOLD switches 20 having been activated. When the CPU 66 determines no reception of a detection signal, it advances the processing to Step S43. On the other hand, when the CPU 66 determines the reception of a detection signal, it advances the processing to Step S42.

In Step S42, the CPU 66 executes processing for holding the corresponding cards. In this processing, the CPU 66 sets a card not to be exchanged, which corresponds to a HOLD switch 20 having been activated in the Step S31, even if the DEAL switch 24 is activated. At the same time, the CPU 66 controls the text “HELD” to be displayed on the image of the card on the first display 32. Upon completion of the processing for holding the corresponding cards, the CPU 66 advances the processing to Step S43.

The CPU 66 executes processing in Step S43 for determining whether or not the DEAL switch 24 has been activated. The CPU 66 determines whether or not to have received a signal indicating detection of the DEAL switch 24 having been activated. When the CPU 66 determines not to have received a detection signal, it returns the processing to Step S41. On the other hand, when the CPU 66 determines to have received a detection signal, it advances the processing to Step S44.

In Step S44, the CPU 66 executes processing for determining exchange cards. The CPU 66 selects cards in accordance with the number of exchange requested by the player out of the five cards kept in stock, which have been selected by lottery in the aforementioned Step S12 (FIG. 4). The number of exchange corresponds to the number of cards that are not held. It may be possible to determine the cards by lottery in this step. Alternatively, it may be possible that the CPU 66 selects the cards according to a ranking order, which is assigned to the five cards kept in stock in Step S12. In this connection, the number of cards to be exchanged according to the request by the player can be five, i.e., all the cards first distributed to the player. Upon completion of the processing for determining exchange cards, the CPU 66 advances the processing to Step S45.

In Step S45, the CPU 66 executes the card re-display processing. In this processing, the CPU 66 transmits to the display control device 200 the data related to the cards used for the card exchange, which have been determined in the aforementioned Step S34. The CPU 66 instructs the display control device 200 to replace the cards, which are not held among the five cards displayed on the first display 32, with the exchange cards. A detailed description is provided later regarding this processing. Upon completion of the card re-display processing, the CPU 66 terminates this card exchange processing subroutine.

h. Card Re-display Processing

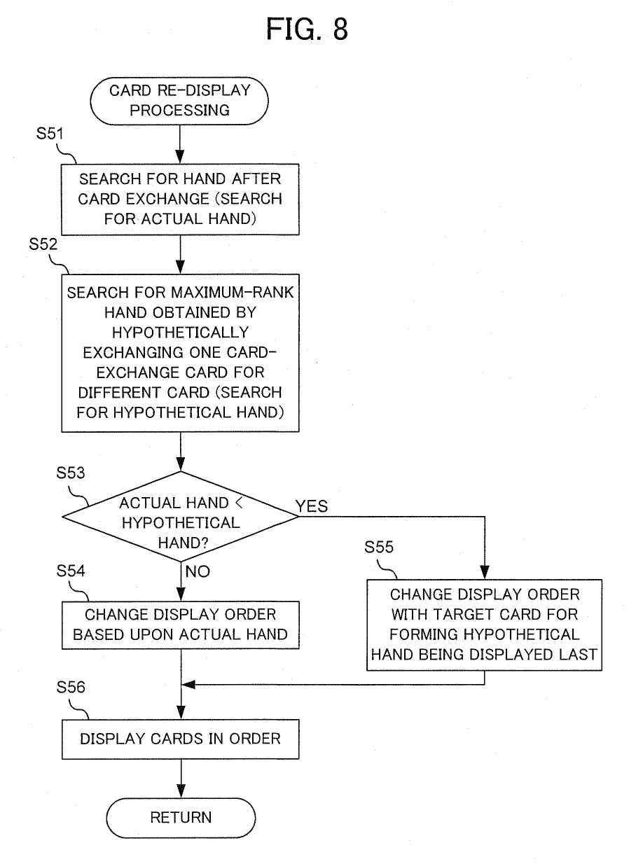

A description is provided regarding the card re-display processing called in Step S45 (FIG. 7) with reference to FIG. 8. More specifically, a description is given of an exemplary case with reference to FIG. 8. In this case, the ten of spades, the jack of spades, the queen of spades, the three of diamonds and the two of diamonds are first displayed, and the player selects the ten of spades, the jack of spades, and the queen of spades as the cards to be held. Subsequently, the jack of diamonds and the king of spades are selected by lottery as the cards replacing the two remaining cards.

First, the CPU 66 searches for a hand formed by a combination of the cards which have been held and the exchange cards (Step S51). Upon completion of the card exchange, this hand is settled. Accordingly, this hand is referred to as a “settled hand” hereafter. The CPU 66 searches the hands stored in the ROM 68 based upon the combination of the held cards and the exchanged cards.

The ROM 68 stores the various poker hands, such as royal flush, straight flush, etc., and the data of the ranking of these poker hands. More specifically, the rank of each poker hand matches the number of medals which are paid out according to the hand when the player bets one medal on the game. For example, the rank is specified in an award table displayed on the first display 32 shown in FIG. 3. Ranks are assigned in a following manner, for example: a royal flush hand has 500, a straight flush hand has 50, and a four of a type hand has 20. With such an arrangement, the value is larger as the poker hand rank is higher. It should be noted that the series of numbers “1”, “2”, and “3” may be employed as long as they represent the ranks of poker hands. The CPU 66 searches the combinations of the newly displayed exchange cards and the held cards for the poker hand having the highest rank. With the present embodiment, as a result of the card exchange, the hand of one pair consisting of the jack of spades and the jack of diamonds is detected as an actual hand.

In the following Step S52, the CPU 66 hypothetically exchanges one of the exchange cards with another card such that the combination of the held cards and the exchange cards thus hypothetically exchanged forms a hand with the highest rank. The hand thus hypothetically formed is referred to as a “hypothetical hand” hereafter. First, the CPU 66 hypothetically replaces the jack of diamonds, which is one of the exchange cards, with another type of card, thereby generating a hypothetical combination. The CPU 66 searches for a hypothetical hand having the highest rank with the hypothetical combination, the exchange cards thus hypothetically exchanged and the held cards. More specifically, the CPU 66 searches for the hypothetical hand that exhibits the highest rank, while hypothetically replacing the jack of diamonds with another type of card. In this case, if the jack of diamonds is replaced with the ace of spades, a royal flush hand is formed.

Next, the CPU 66 searches for a hand having the highest rank while replacing the king of spades, which is the other one of the exchange cards, with another card. In this case, if the king of spades is replaced with the queen of diamonds, a hand of two pairs consisting of jacks and queens is formed. Here, the hand of a royal flush, which is formed in the former search step, exhibits a higher rank than that of the hand of two pairs. Accordingly, the hand of a royal flush, which is formed by hypothetically exchanging the jack of diamonds, is detected as the hypothetical hand that exhibits the highest rank.

Next, the CPU 66 compares the rank of the actual hand obtained in Step S51 with the rank of the hypothetical hand obtained in Step S52 (Step S53). When the rank of the hypothetical hand is higher than that of the actual hand, the CPU 66 advances the processing to Step S55. Otherwise, the CPU 66 advances the processing to Step S54.

In Step S54, the CPU 66 changes the display order based on the actual hand. For example, if the actual hand is one pair consisting of the jack of spades and the jack of diamonds, the jack of diamonds, which has been selected from the exchange cards, is displayed before the jack of spades.

On the other hand, in Step S55, the CPU 66 changes the display order based upon the hypothetical hand. Specifically, the CPU 66 changes the display order such that a target card to complete the hypothetical hand is displayed last. In this case, since the target card to complete the hypothetical hand of a royal flush is the jack of diamonds, the CPU 66 changes the display order to display the jack of diamonds card last.

In the following Step S56, the CPU 66 controls a display of the exchange cards according to the display order. Specifically, the CPU 66 first transmits an instruction to display an image of the first exchange card to the display control device 200 via the input/output bus 64 and the interface circuit group 72. The display control device 200 reads out the corresponding image data, and stores it in the video RAM included in the display control device 200. As a result, the first display 32 displays the exchange card. Subsequently, the CPU 66 performs time delay processing for waiting for a predetermined period of time, e.g., 0.2 to 2 seconds. Then, the CPU 66 transmits an instruction to display an image of the second exchange card to the display control device 200, which controls the first display 32 to display the second exchange card. As described above, the exchange cards are sequentially displayed with intervals provided by the time delay processing.

In the processing for sequentially displaying the exchange cards, for example, of the two exchange cards displayed face down, the first exchange cards is turned face up to display the king of spades. This induces the player to expect the formation of a royal flush, which would be formed if the other exchange card remaining face down is the ace of spades. The other exchange card is eventually turned face up to be the jack of diamonds. Accordingly, only the hand of one pair is formed as an actual hand.

By changing the display order of the exchange cards based upon the hypothetical hand as described above, it is possible to allow the player to feel expected to obtain a hand until a display of the last exchange card. Upon completion of this processing, the CPU 66 terminates the processing of this subroutine.

With the aforementioned present embodiment, the poker gaming machine 10 firstly displays a part of the cards related to a card combination. However, the present invention is not restricted to such an arrangement. It may be alternatively possible to display cards in other display orders which enhance the player's expectation. For example, it may be possible to display all the cards related to a card combination prior to the other cards. Specifically, in this case, the ace of hearts, the ace of diamonds, and the four of diamonds are displayed in this order. In addition, it may be possible to display the unrelated cards prior to the related cards, when the player exchanges all five cards. As the card display advances, the card combination is more formed. Therefore, the player takes great pleasure in the formation of the card combination.

i. Result Determination Processing

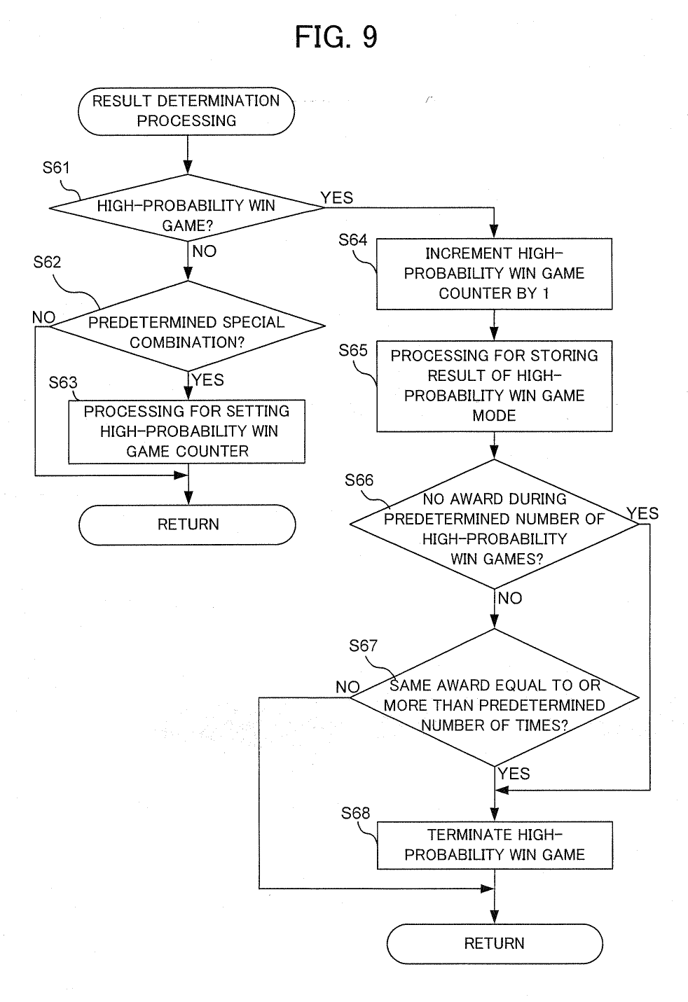

A description is provided regarding the result determination processing called in Step S15 (FIG. 4) with reference to FIG. 9.

In Step S61, the CPU 66 determines whether or not the game is in a high-probability win game mode. When the CPU 66 has determined that the game is in a high-probability win game mode based upon a game mode flag stored in the RAM 70, the CPU 66 advances the processing to Step S64. Otherwise, the CPU 66 advances the processing to Step S62.

In Step S62, the CPU 66 performs processing for determining whether or not a card combination matches a predetermined special combination. When the CPU 66 determines that the predetermined special combination has been formed, the CPU 66 sets the game mode flag stored in the RAM 70 to a value corresponding to the predetermined special combination thus formed. When the CPU 66 has determined that a predetermined special combination (e.g., heart flush or diamond flush) has been formed, the CPU 66 advances the processing to Step S63. Otherwise, the CPU 66 terminates this subroutine. According to the game mode flag thus varied, the CPU 66 executes a subsequent game in the high-probability win game mode.

In Step S63, the CPU 66 performs processing for setting high-probability win game counter. In this processing, the CPU 66 sets the counter value of the high-probability win game counter stored in the RAM 70 to the number of the high-probability win games to be continuously executed according to the predetermined card combination. Upon completion of this processing, the CPU 66 terminates this subroutine.

In Step S64, the CPU 66 performs processing for incrementing the high-probability win game counter value of the high-probability win game counter stored in the RAM 70. In this processing, the CPU 66 increments the counter value by 1. Upon completion of this processing, the CPU 66 advances the processing to Step S65.

In Step S65, the CPU 66 performs processing for storing high-probability win game result. In this processing, the CPU 66 determines the win game result in the high-probability win game mode. Furthermore, the CPU 66 stores the win game result (game result data) in the RAM 70, in addition to the counter value of the high-probability win game counter. Upon completion of this processing, the CPU 66 advances the processing to Step S66.

In Step S66, the CPU 66 determines whether or not an award has been provided during a predetermined number of games thus executed. In this processing, the CPU 66 uses, as the reference data, the game result data of the multiple previous games (e.g., five previous games) stored in Step S65. When the CPU 66 has determined that the award has not been performed during the predetermined number of previous games, the CPU 66 advances the processing to Step S68. Otherwise, the CPU 66 advances the processing to Step S67.

In Step S67, the CPU determines whether or not a same award has been provided equal to or more than a predetermined number of times. In this processing, the CPU 66 uses, as the reference data, the game result data of multiple previous games (e.g., five previous games). Specifically, the CPU 66 determines whether or not the same award has been provided (e.g., the lowest-rank award has been provided twice, etc.) during the predetermined number of previous games (e.g., five previous games). When the CPU 66 has determined that the same award has been performed, the CPU 66 advances the processing to Step S68. Otherwise, the CPU 66 terminates this subroutine.

In Step S68, the CPU 66 performs processing for terminating the high-probability win game. In this processing, the CPU 66 varies the value of the game mode flag (e.g., varies the value from 1 to 0), which terminates the high-probability win game. Upon completion of this processing, the CPU 66 terminates this subroutine.

As described above, the CPU 66 is an example of a controller to first distribute cards to a player, performing exchange for the cards according to the selection made by the player. Subsequently, the controller executes a win game, which provides a predetermined award when the final cards possessed by the player have a predetermined combination.

Furthermore, the CPU 66 is an example of a controller which provides the following functions: when a card combination matches a predetermined special combination, the controller continuously executes a plurality of subsequent win games in a high-probability win game mode. In addition, the CPU 66 is an example of a controller providing the following functions: when a predetermined award-providing condition has been satisfied during a predetermined number of high-probability win games continuously executed, the controller terminates the execution of the high-probability win game. Moreover, the CPU 66 is an example of a controller which provides the following functions: when a low award has been continuously provided equal to or more than a predetermined number of times, the controller terminates the execution of the high-probability win game. Forthermore, the CPU 66 is an example of a controller which provides the following functions: when a same award has been continuously provided equal to or more than a predetermined number of times, the controller terminates the execution of the high-probability win game. The first display 32 is an example of a display that is controlled by the controller to display images related to the win game. Furthermore, the first display 32 is an example of a display which displays at least one special card assigned to multiple types of cards in the distributed cards, when a game is in the high-probability win game mode.

j. The Poker Gaming Machine Display

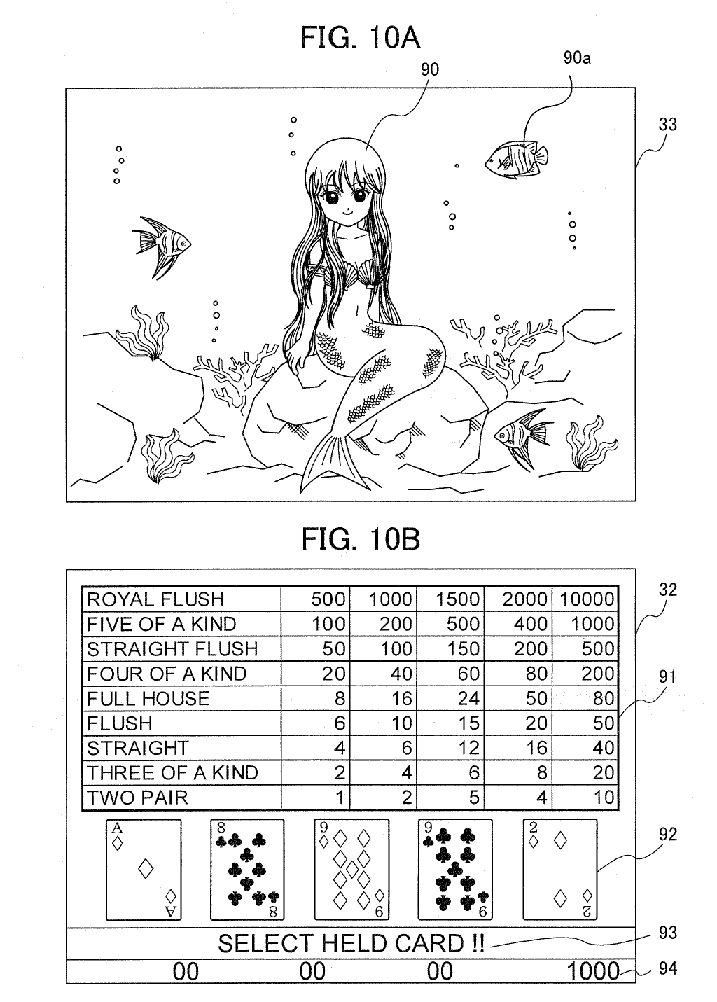

FIGS. 10A and 10B are schematic diagrams illustrating examples of the display screens. As shown in FIG. 10A, the second display 33 displays a character image 90 (e.g., an image depicting a seated mermaid, etc.), and a character image 90a (e.g., an image depicting fish swimming in water). As shown in FIG. 10B, the first display 32 displays a character image 91 (e.g., an image depicting the poker award table), a character image 92 (e.g., an image depicting multiple cards, etc.), a text image 93 (e.g., a text image depicting “SELECT HELD CARD!!” etc.), and a text image 94 indicating the points (e.g., “00 00 00 1000” etc.).

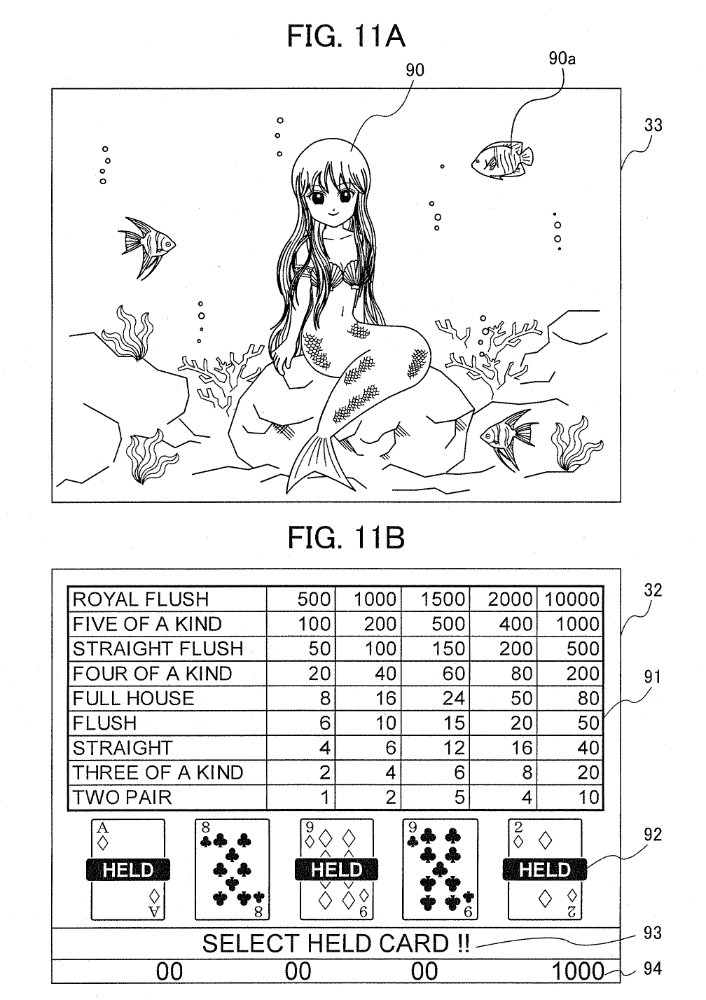

FIGS. 11A and 11B are schematic diagrams illustrating examples of the display screens after the HOLD switch being manipulated when the first display 32 is displaying the screen image shown in FIGS. 10A and 10B. As shown in FIG. 11A, the second display 33 displays the similar character images as those depicted in FIG. 10A. As shown in FIG. 11B, the first display 32 displays the character image 91, the text image 93, and the text image 94 similar to those shown in FIG. 10B. The first display 32 displays a character image 92 (e.g., an image depicting multiple cards and text images depicting “HELD”).

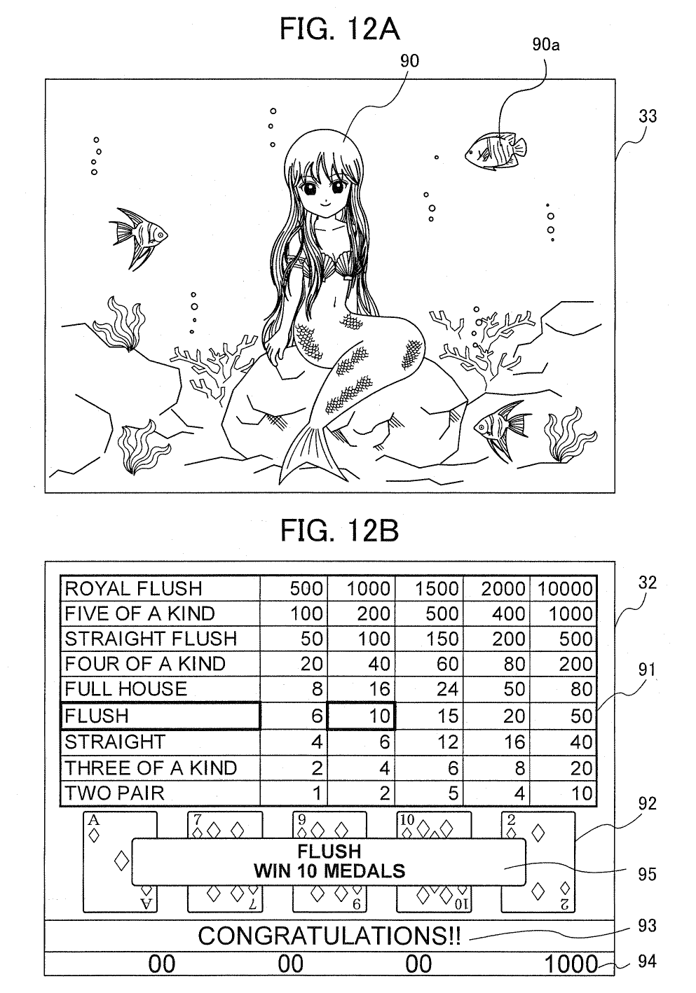

FIGS. 12A and 12B are schematic diagrams showing examples of the display screens after the DEAL switch 24 being manipulated. As shown in FIG. 12A, the second display 33 displays the similar character images as those depicted in FIG. 11A. As shown in FIG. 11B, the first display 32 displays a character image 91 (e.g., an image depicting the poker award table in which the texts “FLUSH” and “10” are highlighted), a character image 92 (e.g., an image depicting multiple cards), and a text image 93 (e.g., a text image depicting “CONGRATULATIONS!!”). Furthermore, the first display 32 displays the text image 94, which indicates the points (e.g., “1000” etc.), and a text image 95 (e.g., “FLUSH WIN 10 MEDALS”, etc.).

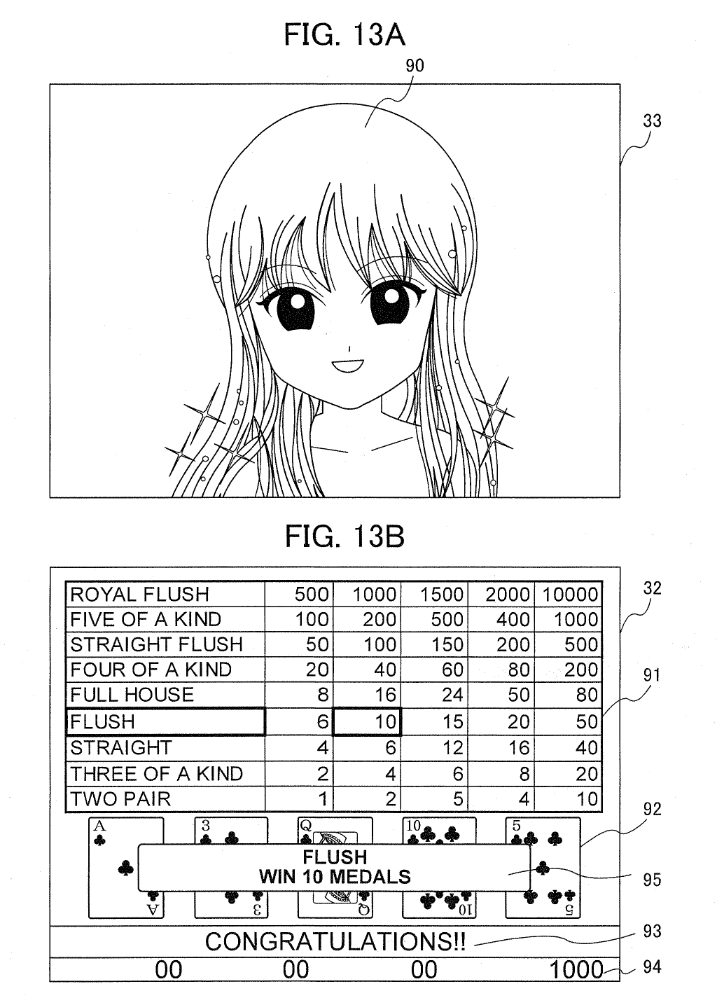

FIGS. 13A and 13B are schematic diagrams showing examples of the display screens when a win game enters the high-probability win game mode. As shown in FIG. 13A, the second display 33 displays a character image 90 (e.g., an image depicting a close-up view of the face of a mermaid, etc.). As shown in FIG. 13B, the first display 32 displays a character image 91 (e.g., an image depicting the poker award table in which the texts “FLUSH” and “10” are highlighted), a character image 92 (e.g., an image depicting multiple cards), a text image 93 (e.g., a text image depicting “CONGRATULATIONS!!”). Furthermore, the first display 32 displays a text image 94, which indicates the points (e.g., “1000”, etc.) and a text image 95 (e.g., “FLUSH WIN 10 MEDALS”, etc.).

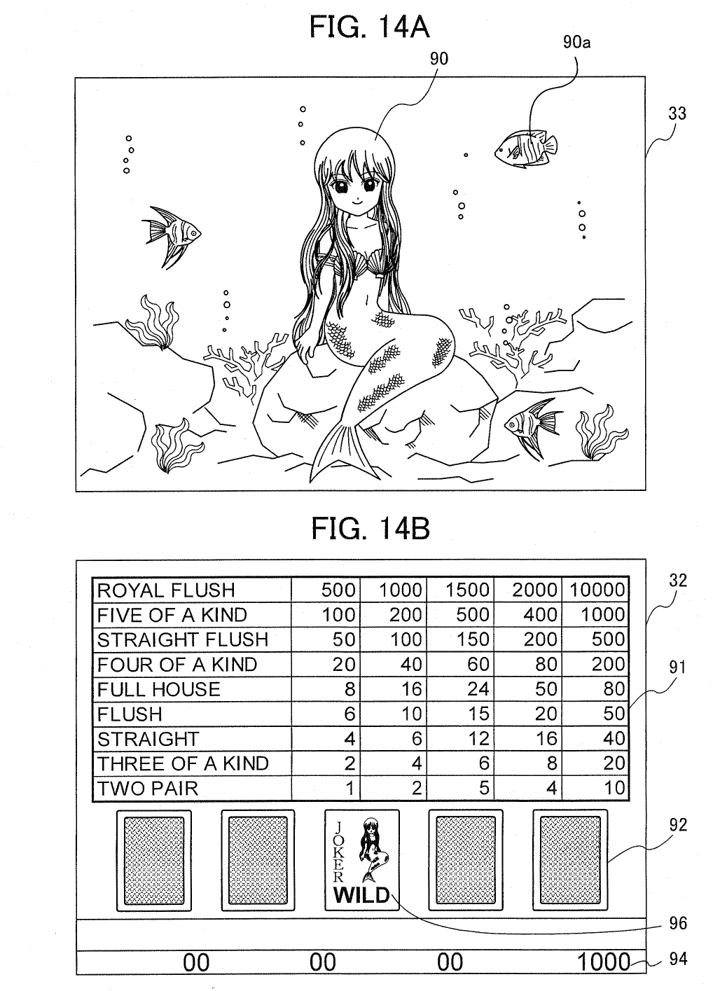

FIGS. 14A and 14B are schematic diagrams showing examples of the display screens in the high-probability win game mode. As shown in FIG. 14A, the second display 33 displays the similar character images to those depicted in FIG. 10A. As shown in FIG. 14B, the first display 32 displays a character image 91 (e.g., an image depicting the poker award table), a character image 92 (e.g., an image depicting multiple cards displayed face down), and a text image 94, which indicates the points (e.g., “1000”, etc.). In addition, the first display 32 displays a character image 96 (e.g., an image of a card with an illustration of a mermaid, which is used for setting a game in the high-probability win game mode).

A description has been provided regarding arrangements with reference to the embodiments. The present invention is not restricted to such arrangements. It should be understood that the scope readily conceived by those skilled in this art and the replacement of each component with an equivalent or a substitute also belong to the technical scope of the present invention.

What is claimed is:

1. A gaming machine comprising:
a display; and
a controller that controls the display so as to display an image related to a win game, wherein
the controller is configured with logic to:
(a) distribute cards to a player;
(b) replace one or more of the distributed cards selected by the player with different cards;
(c) execute a win game in which the player wins a predetermined award when the final cards possessed by the player include a predetermined card combination;
(d) continuously execute a plurality of subsequent win games in a high-probability mode when the card combination entitled to the award matches a predetermined special combination; and
(e) terminate the win game in the high-probability mode, when awards provided during a first predetermined number of the win games have satisfied a predetermined condition.

2. The gaming machine according to claim 1, wherein the controller is further configured with logic to (f) terminate the win game in the high-probability mode, when a low award has been continuously provided equal to or more than a second predetermined number of times.

3. The gaming machine according to claim 2, wherein the controller is further configured with logic to (g) terminate the win game in the high-probability mode, when a same award has been continuously provided equal to or more than a third predetermined number of times.

4. The gaming machine according to claim 1, wherein the controller is further configured with logic to (g) terminate the win game in the high-probability mode, when a same award has been continuously provided equal to or more than a third predetermined number of times.

5. A gaming machine comprising:
a display; and
a controller that controls the display so as to display an image related to a win game, wherein
the controller is configured with logic to:
(a) distribute cards to a player;
(b) replace one or more of the distributed cards selected by the player with different cards;
(c) execute a win game in which the player wins a predetermined award when the final cards possessed by the player include a predetermined card combination;
(d) continuously execute a plurality of subsequent win games in a high-probability mode when the card combination entitled to the award matches a predetermined special combination;
(e) terminate the win game in the high-probability mode, when awards provided during a first predetermined number of the win games have satisfied a predetermined condition; and
(f) terminate the win game in the high-probability mode, when a low award has been continuously provided equal to or more than a second predetermined number of times.

6. The gaming machine according to claim 5, wherein the controller is further configured with logic to (g) terminate the win game in the high-probability mode, when a same award has been continuously provided equal to or more than a third predetermined number of times.

7. A gaming machine comprising:
a display; and
a controller that controls the display so as to display an image related to a win game, wherein
the controller is configured with logic to:
(a) distribute cards to a player;
(b) replace one or more of the distributed cards selected by the player with different cards;
(c) execute a win game in which the player wins a predetermined award when the final cards possessed by the player include a predetermined card combination;
(d) continuously execute a plurality of subsequent win games in a high-probability mode when the card combination entitled to the award matches a predetermined special combination;
(e) terminate the win game in the high-probability mode, when awards provided during a first predetermined number of the win games have satisfied a predetermined condition;
(f) terminate the win game in the high-probability mode, when a low award has been continuously provided equal to or more than a second predetermined number of times; and
(g) terminate the win game in the high-probability mode, when a same award has been continuously provided equal to or more than a third predetermined number of times.

8. A method of controlling a gaming machine, comprising the steps of:
(a) distributing cards to a player;
(b) replacing one or more of the distributed cards selected by the player with different cards;
(c) executing a win game in which the player wins a predetermined award when the final cards possessed by the player include a predetermined card combination;
(d) continuously executing a plurality of subsequent win games in a high-probability mode when the card combination entitled to the award matches a predetermined special combination; and
(e) terminating the win game in the high-probability mode, when awards provided during a first predetermined number of the win games have satisfied a predetermined condition.

9. The method according to claim 8, further comprising the step of: (f) terminating the win game in the high-probability mode, when a low award has been continuously provided equal to or more than a second predetermined number of times.

10. The method according to claim 9, further comprising the step of: (g) terminating the win game in the high-probability mode, when a same award has been continuously provided equal to or more than a third predetermined number of times.

11. The method according to claim 8, further comprising the step of: (g) terminating the win game in the high-probability mode, when a same award has been continuously provided equal to or more than a third predetermined number of times.

12. A method of executing a win game, the method comprising the steps of:
(a) distributing cards to a player;
(b) replacing one or more of the distributed cards selected by the player with different cards;
(c) executing a win game in which the player wins a predetermined award when the final cards possessed by the player include a predetermined card combination;
(d) continuously executing a plurality of subsequent win games in a high-probability mode when the card combination entitled to the award matches a predetermined special combination; and
(e) terminating the win game in the high-probability mode, when awards provided during a first predetermined number of the win games have satisfied a predetermined condition.
